(19) United States
(12) Patent Application Publication
(10) Pub. No.: US 2023/0162307 A1
(43) Pub. Date: May 25, 2023

(54) PUBLIC SAFETY INTEGRATED PLATFORM

(71) Applicants: AT&T Intellectual Property I, L.P., Atlanta, GA (US); AT&T Mobility II LLC, Atlanta, GA (US)

(72) Inventors: Eric Morris, Arlington, TX (US); Mingwun Li, Dallas, TX (US); Cindy McIntosh, Federal Way, WA (US); Andrew Fuller, Greensboro, NC (US)

(21) Appl. No.: 17/533,603

(22) Filed: Nov. 23, 2021

(51) Int. Cl. G06Q 50/26

(52) U.S. Cl. CPC G06Q 50/265

(57) ABSTRACT

A system for a public safety integrated platform that may allow for the integration of body cameras, location tracking, biometrics tracking, wayfinding/navigation, or other applications.

### BACKGROUND

Most disasters occur without warning, and all require a rapid and flawless response with no room for error. Even if there is a warning, for example, with an approaching hurricane, the location and severity of the hurricane is not necessarily known in advance. Timely, multi-disciplinary, coordinated responses across agency lines are mission-critical to protect the communities and citizens that public safety first responders are charged to serve. Whether the event is a fire, natural disaster, vehicular collision, act of terrorism, or apprehension of suspects, highly-available, low access-latency networks, real-time data collection, and reliable, actionable analytics provide the common denominator to successful rapid response.

This background information is provided to reveal information believed by the applicant to be of possible relevance. No admission is necessarily intended, nor should be construed, that any of the preceding information constitutes prior art.

### SUMMARY

There are multiple devices that are conventionally used with public safety. The disclosed public safety platform may enable a coordinated response, which may allow for dispatch, command, and first responders to have a common operating picture.

In an example, an apparatus may include a processor and a memory coupled with the processor that effectuates operations. The operations may include receiving public safety related information from multiple sources in various data types; creating a first group of anonymized information based on the various data types; creating a second group of partially or not anonymized public safety related information based on the various data types; processing the first group of anonymized data for a first authorization level; processing the second group of partially or not anonymized data for a second authorization level; and displaying the first group or second group of public safety related information based on authorization level.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrate an exemplary system that may implement a public safety integrated platform;

FIG. 2 illustrates an exemplary user interface for a public safety integrated platform;

FIG. 3 illustrates an exemplary method associated with a public safety integrated platform;

FIG. 4 illustrates an exemplary method associated with a public safety integrated platform;

FIG. 5 illustrates a schematic of an exemplary network device.

FIG. 6 illustrates an exemplary communication system that provides wireless telecommunication services over wireless communication networks.

### DETAILED DESCRIPTION

The public safety integrated platform brings multiple independent approaches together for public safety users. The platform provides a single mapping and location analysis approach for public safety users to leverage as needed. A user interface component to the platform may be integrated into applications on various devices, such as desktop computers, smartphones, or tablet computers. The platform may have application programming interfaces (APIs) that may be used by edge applications, as needed, for a consistent and integrated mapping experience for the public safety users across numerous implementations in the market.

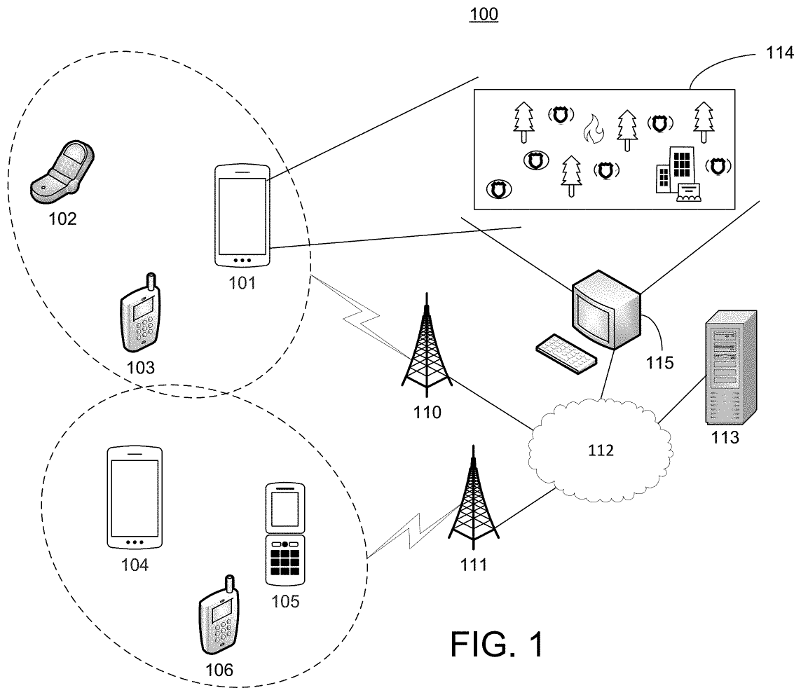

FIG. 1 illustrates an exemplary system that may implement a public safety integrated platform. System 100 may include multiple devices such as mobile device 101—mobile device 106, base station 110, base station 111, server 113, or desktop 115 that are communicatively connected with each other. The devices of system 100 may be communicatively connected with each other via network 112. Network 112 may include vRouters, access points, DNS servers, firewalls, or the like (not shown).

With continued reference to FIG. 1, mobile device 101 may include a laptop, tablet, autonomous vehicle (e.g., SAE Intl level 3 to level 5 automation), or mobile phone, among other things. Mobile device 101 may include wireless or wired communication devices. Server 113 may receive, process, or distribute information associated with public safety users. For example, server 113 may receive information associated with a public safety event, information associated with identification of persons at a public safety event (e.g., identifying via device user profile or facial recognition), or information associated with location of public safety personnel. After processing such information server 113 may allow access to the processed or raw information to mobile device 101 or desktop 115, for example. The processed or raw information may be accessed via use of a graphical (or text) user interface that may be displayed, such as display 114. As shown, display 114 may include a map, which may include locations of landmarks, public safety personnel, current public safety issues (e.g., fire, flood, crime, etc.), or forecasted public safety issues, among other things.

It is contemplated that mobile device 101—mobile device 106 may have different operating systems, applications, or different levels of processing power. For example, mobile device 101 may have a fully installed and updated public safety application that communicates with server 113, while mobile device 105 may be a simpler device that relies somewhat on external devices, such as server 113 (or mobile device 104), to obtain or process information associated with a public safety user. In an example scenario, mobile device 105 may be registered with the public safety integrated platform based on an identifier (e.g., international mobile subscriber identity (IMSI)) which may allow for data to be captured and processed by the network (e.g., server 113 or other devices of network 112) and nearby mobile device 104 may capture information with regard to mobile device 105 via audio, video, or captured signals (e.g., Wi-Fi or Bluetooth). The disclosed public safety integrated platform with the use of an API may increase the number of varied devices and applications that may be integrated into a single platform and thereafter displayed on a user interface or allow for increased communication between public safety users.

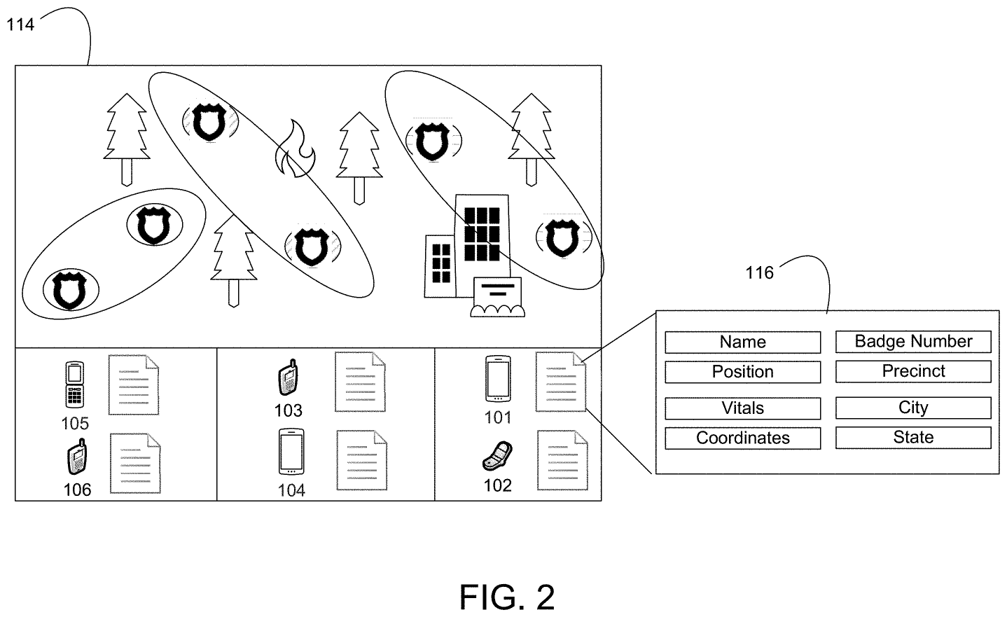

FIG. 2 illustrates an exemplary user interface for a public safety integrated platform. In an exemplary scenario, there may be a need for various public safety personnel, such as fire personnel, police personnel, or emergency medical services (EMS) personnel, for a public safety event, e.g., wildfire. These public safety personnel may be from different public safety agencies, while also being from different cities, counties, or states. The public safety integrated platform allows for each public safety user to register their involvement with the public safety event, which may be done automatically (e.g., via location). When registered a dispatcher or other public safety user may have access to various information (based on authorization level). The information may include instructions on desired location of the public safety user; display of responders, vehicles, or markers on a single console; access to different map layers for different types of incidents (e.g., weather layer for natural disasters); ability to access or create polygons to invoke group actions such as create messaging group and create PTT group for faster collaboration; and read and send messages, which are integrated across multiple messaging solutions from 3^{rd} party messaging apps and push-to-talk (PTT) chats, among other things. Other information that may be received is mutual aid consent, network tower location, network tower status, photos, interview forms, command posts, user messages, ESRI Coverage Area (e.g., via geographic information system (GIS)), etc.

As shown in FIG. 2, in block 116, there may be access to various information of each public safety user or public safety asset (e.g., vehicle or equipment), such as name, position, vitals, coordinates, badge number, home precinct, home city, or home state, among other things. The display may be a user interface that may allow for selection and viewing of other responder information, such as call sign, role, specialties, or applications logged into. The display may also allow for creation or viewing of incidents with details, such as assigned units, location, or Incident Command Structure support. In addition, the creation and viewing may include markers to call attention to alerts, stage blockades, positioning for incident response, or breadcrumbs (e.g., track logs) that allow decision makers to ensure completeness of search, among other things.

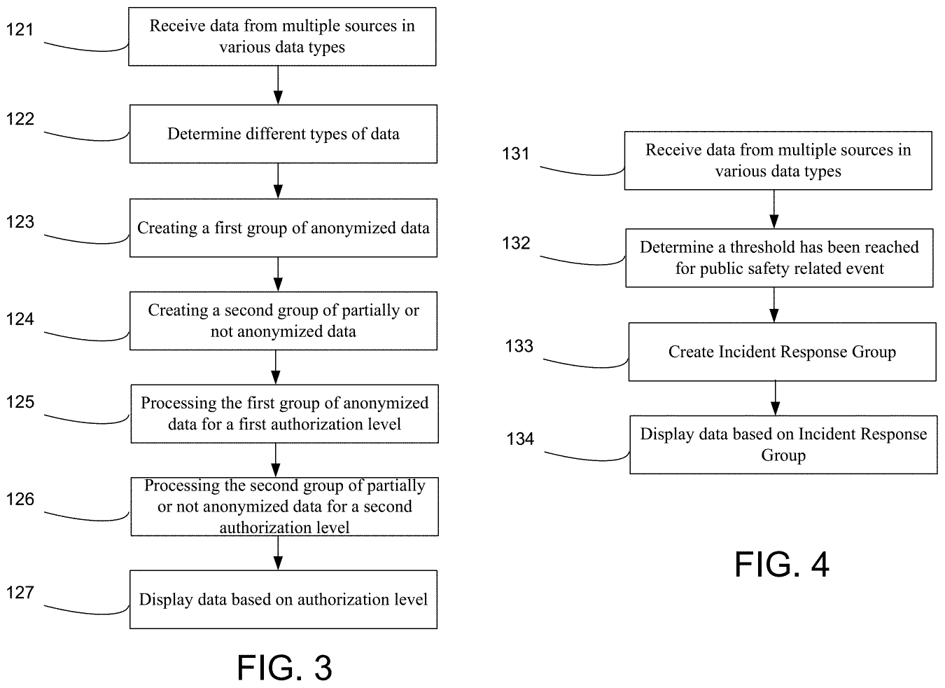

FIG. 3 illustrates an exemplary method associated with implementing a public safety integrated platform. At step 121, a device (e.g., server 113 or mobile device 101) may receive data from multiple sources, which may be associated with different devices, data types, or applications. For example, the information may be from sensors associated with bodycams, drones, mobile phones, autos, building alarm systems, or satellites, among other things. Each of the devices may run different applications that may provide different types of data. The platform may use a data ingestion and correlation framework that allows the activities, such as location ingestion or user correlation activities, to occur at very high throughput rates. Location ingestion events may be correlated with billing. At step 122, the device may determine the different types of data. The different types of data may be associated with a public safety event, public safety users, public safety assets, or the like.

At step 123, the device may create a first group of anonymized data based on the data and indicated types. This anonymization may allow for broader use of data for viewing (e.g., low level of authorization), research, or near real time forecasting. At step 124, the device may create a second group of non-anonymized (or partially anonymized) data based on the data and indicated types. This non-anonymized data may be used for more restricted use for viewing (e.g., high level of authorization) on a real time reactive basis. At step 125, the device may process the first group of anonymized data for a first authorization level. At step 126, the device may process the second group of non-anonymized (or partially anonymized) data for a second authorization level. It is contemplated that there may be several levels of authorization and anonymization. The processing may include converting data from one format to another format or combining different data to create new data (e.g., forecast based on historical data).

With continued reference to FIG. 3, there may be a display of public safety related information (e.g., processed data of step 125 and step 126) based on the authorization level. In an example scenario, a public safety user with mobile device 101 may have access to display information as shown in block 116 of FIG. 2 for multiple users, which may include positioning of all public safety personnel for the public safety event, detailed background information for each public safety personnel at the site and approaching the site. While other public safety users, such as a public safety user of mobile device 104, may only have more restricted access to display the information (e.g., just EMS public safety users, just public safety assets, general map of public safety user positions, etc.).

The rigorous data ingestion process in the platform allows for granular filtering and grouping of first responder disciplines on a map or other ways on the display. The analysis processes that run in the platform may allow for instant updates to be seen by all users for situational awareness. A way to achieve this level of processing and display is through a tightly coupled event management approach that is powering a user interface experience that expects data to change frequently, e.g., every second. The user experience may be optimized by processing logic that prevents location “jumping” and location “disappearing” of people, assets, or objects seen on the map.

FIG. 4 illustrates an exemplary method associated with implementing a public safety integrated platform. At step 131, a device may receive information (e.g., data) from multiple sources, which may be associated with different devices, data types, or applications. For example, the information may be from sensors associated with bodycams, drones, mobile phones, autos, building alarm systems, or satellites, among other things. The information may include public safety personnel office location, hours of operations, expertise, or the like. At step 132, a device may detect an event trigger based on the information of step 131. An example event trigger may include a fire detected (e.g., drone or satellite video of fire), a threshold being reached (e.g., water level sensor indicating a flood), or a vehicle crash detected, among others. The different types of data may be associated with a public safety event, public safety assets, or the like.

At step 133, in response to the event trigger an incident response group may be automatically created. The incident response group may include one or a group of different agencies. For example, a wildfire event near a populated area may require fire personnel, police, and EMS. Creating an incident response group may include linking the lines of communication between agencies and public safety personnel. In an example, a PTT talk group with the nearest officers and EMS can be created to share the emergency with location information. In another example, an application on a mobile device may be used to connect the appropriate personnel. At step 134, information associated with the incident response group may be displayed, such as display 114. The information displayed to each of the devices of the public safety personnel in the incident response group may be based on authorization level of the public safety personnel. It is contemplated herein that the steps in FIG. 3, FIG. 4, or throughout the application may be distributed over multiple devices (e.g., mobile device 101 or base station 111 instead of server 113).

There are multiple scenarios for using the public safety integrated platform. In a scenario, a communication may be received with regard to an officer down. In this scenario, an alert may be generated from pushing an emergency button on a radio, autodetection from a body worn sensor, or the like that an officer is down. The location of the down officer may be found considering z-axis information. The alert may be displayed on a dispatcher user interface. The user interface may indicate that the officer's biometrics are out of range, may allow for automated attempts to communicate with the officer, or create a PTT talk group with the nearest officers and EMS to share the emergency with location information, such as floor level. Responding officers may have displayed on their mobile device the quickest path to the location. If there is no response by the downed officer, the body camera may be triggered to turn on, and the body camera video may be automatically shared with the nearby officers, which may show the environment (e.g., a person fleeing the scene). Markers can be created by searchers or commanders to indicate areas of evidence. Evidence photos may be uploaded to platform, which may viewable to an incident group.

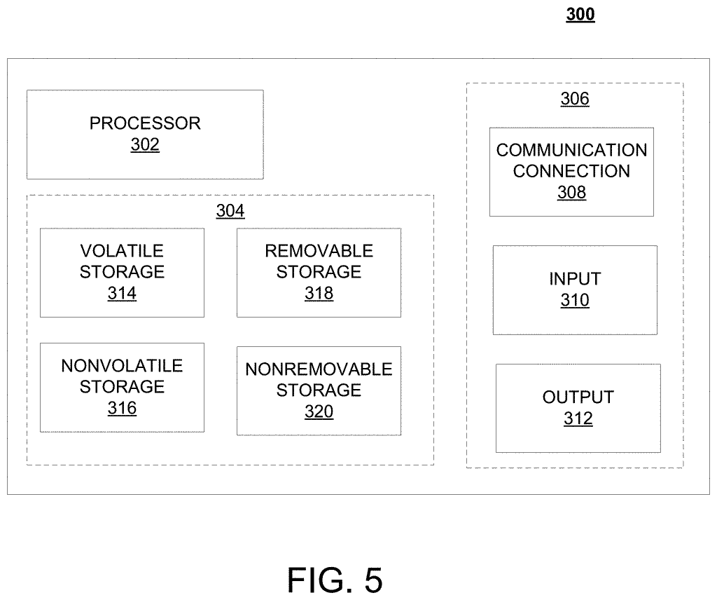

FIG. 5 is a block diagram of network device 300 that may be connected to or comprise a component of system 100. Network device 300 may comprise hardware or a combination of hardware and software. The functionality to facilitate telecommunications via a telecommunications network may reside in one or combination of network devices 300. Network device 300 depicted in FIG. 5 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 5 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 5) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

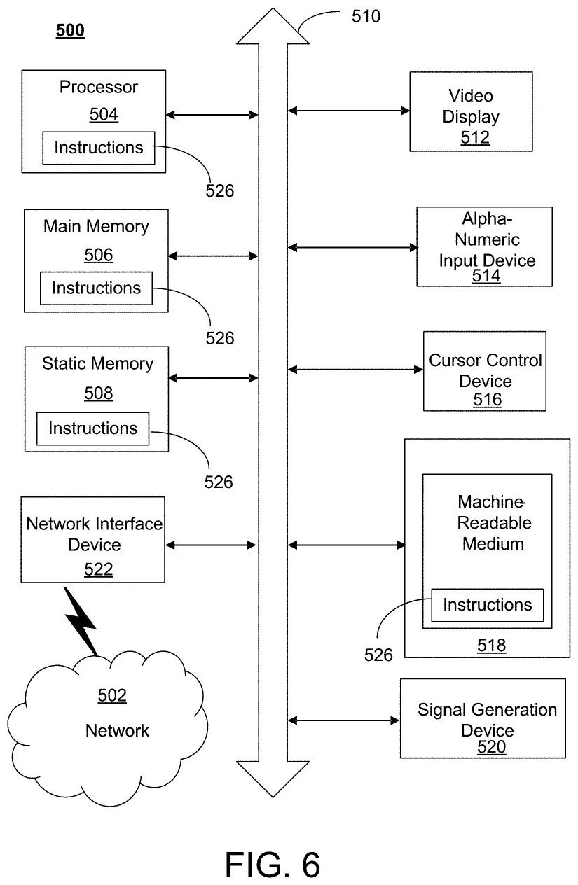

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, mobile device 101—mobile device 106, base station 111, server 113, desktop 115, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which a public safety integrated platform alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—a public safety integrated platform—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for a public safety integrated platform. A method, system, computer readable storage medium, or apparatus provides for receiving information from multiple sources in various data types; determining different types of data; creating a first group of anonymized information (e.g., data); creating a second group of partially or not anonymized information; processing the first group of anonymized data for a first authorization level; processing the second group of partially or not anonymized data for a second authorization level; and displaying the first group or second group of information based on authorization level. A method, system, computer readable storage medium, or apparatus provides for ingesting data from multiple sources in various data types (internal, external, unstructured, etc.); combining raw data (search area, FN user location, messages, forms, etc.) with reference data, group info, privacy consent, mutual aid consent, etc.; and enriching the data. The enriching may include anonymizing or correlating to user. The data may be summarized or anonymized to be consumed by more general authorization. A public safety user (e.g., first responder or public safety personnel) may have user specific data generated to be consumed only by a particular authorized group (e.g., a particular public safety entity). A method, system, computer readable storage medium, or apparatus provides for receiving public safety related data from multiple sources; determining different types of public safety related data; based on the different types of public safety related data, creating a first group of anonymized data; based on the different types of public safety related data, creating a second group of non-anonymized data; processing the first group of anonymized data for a first authorization level; processing the second group of non-anonymized data for a second authorization level; and displaying data based on the first authorization level or second authorization level. When a public safety user is detected of having biometrics above a threshold range, there may be automatic attempt to communicate with the public safety user (e.g., via their mobile device). The attempted communication may be another public safety user (e.g., a dispatcher). All combinations in this paragraph (including the removal or addition of steps) are contemplated in a manner that is consistent with the other portions of the detailed description.

What is claimed:

1. A method comprising:
receiving public safety related data from multiple sources;
creating a first group of anonymized data;
creating a second group of non-anonymized data;
processing the first group of anonymized data for a first authorization level;
processing the second group of non-anonymized data for a second authorization level; and
displaying data for a user interface based on the first authorization level or second authorization level.

2. The method of claim 1, wherein the public safety related data comprises call sign, role, specialties, or applications logged into by a public safety user.

3. The method of claim 1, wherein the public safety related data for the user interface comprises an assigned unit, location, or incident command structure support.

4. The method of claim 1, further comprising when a public safety user is detected of having biometrics above a threshold range, automatically attempting a communication session with a mobile device of the public safety user, wherein the communication session is with another public safety user.

5. The method of claim 1, wherein the public safety related data for the user interface comprises track log markers associated with progress of a search.

6. The method of claim 1, wherein the multiple sources comprise bodycams, drones, or satellites.

7. The method of claim 1, wherein the multiple sources comprise mobile phones, autos, or building alarm systems.

8. An apparatus comprising:
a processor; and
memory coupled with the processor, the memory storing executable instructions that when executed by the processor cause the processor to effectuate operations comprising:
receiving public safety related data from multiple sources;
creating a first group of anonymized data;
creating a second group of non-anonymized data;
processing the first group of anonymized data for a first authorization level;
processing the second group of non-anonymized data for a second authorization level; and
displaying data for a user interface based on the first authorization level or second authorization level.

9. The apparatus of claim 8, wherein the public safety related data comprises call sign, role, specialties, or applications logged into by a public safety user.

10. The apparatus of claim 8, wherein the public safety related data for the user interface comprises an assigned unit, location, or incident command structure support.

11. The apparatus of claim 8, the operations further comprising when a public safety user is detected of having biometrics above a threshold range, automatically attempting a communication session with a mobile device of the public safety user, wherein the communication session is with another public safety user.

12. The apparatus of claim 8, wherein the public safety related data for the user interface comprises track log markers associated with progress of a search.

13. The apparatus of claim 8, wherein the multiple sources comprise bodycams, drones, or satellites.

14. The apparatus of claim 8, wherein the multiple sources comprise mobile phones, autos, or building alarm systems.

15. A computer readable storage medium storing computer executable instructions that when executed by a computing device cause said computing device to effectuate operations comprising:
receiving public safety related data from multiple sources;
creating a first group of anonymized data;
creating a second group of non-anonymized data;
processing the first group of anonymized data for a first authorization level;
processing the second group of non-anonymized data for a second authorization level; and
displaying data for a user interface based on the first authorization level or second authorization level.

16. The computer readable storage medium of claim 15, wherein the public safety related data comprises call sign, role, specialties, or applications logged into by a public safety user.

17. The computer readable storage medium of claim 15, wherein the public safety related data for the user interface comprises an assigned unit, location, or incident command structure support.

18. The computer readable storage medium of claim 15, the operations further comprising when a public safety user is detected of having biometrics above a threshold range, automatically attempting a communication session with a mobile device of the public safety user, wherein the communication session is with another public safety user.

19. The computer readable storage medium of claim 15, wherein the public safety related data for the user interface comprises track log markers associated with progress of a search.

20. The computer readable storage medium of claim 15, wherein the multiple sources comprise bodycams, drones, or satellites.
